(19) United States
(12) Patent Application Publication
(10) Pub. No.: US 2007/0246969 A1
(43) Pub. Date: Oct. 25, 2007

(54) Vehicle extender

(75) Inventors: Donald G. Smith, Portland, OR (US); Chinpai Jong, Tigard, OR (US); Dan Schlesinger, Portland, OR (US)

Correspondence Address: KLARQUIST SPARKMAN, LLP, 121 SW SALMON STREET, SUITE 1600, PORTLAND, OR, 97204, US

(73) Assignee: Freightliner LLC

(21) Appl. No.: 11/788,182

(22) Filed: Apr. 18, 2007

Related U.S. Application Data
(60) Provisional application No. 60/794,041, filed on Apr. 20, 2006.

(51) Int. Cl. B62D 35/00

(52) U.S. Cl. 296/180.2

(57) ABSTRACT

An accessory for a vehicle cab or trailer for directing air flow relative to a downstream or towed trailer has apertures configured to direct some air to the space between the vehicle cab or trailer and the downstream trailer.

### CROSS REFERENCE TO RELATED APPLICATION

This application claims the benefit of U.S. Provisional Application No. 60/794,041, filed Apr. 20, 2006.

### TECHNICAL FIELD

The disclosure relates to an accessory for a cab or trailer of a semi-trailer truck used to direct air flow around a following or downstream trailer.

### BACKGROUND

The gap between the tractor and trailer or between succeeding trailers of a semi-trailer truck causes aerodynamic drag and air turbulence which decreases the fuel efficiency and handling of the truck, especially at highway speeds. To enhance the aerodynamics of the truck, various accessories have been developed to direct air flow smoothly around downstream or following trailers. Such accessories include air fairings and various types of cab extenders to direct air flow over the roof and sides of the trailer.

Cab extenders along the side of a cab must be able to effectively direct airflow while accommodating the relative movement of the tractor and adjacent trailer or between two adjacent trailers during a turn. To allow this relative motion, some cab extenders include mechanical assemblies which enable wind deflectors to pivot about a mechanical joint during a turn.

Cab extenders incorporating a flexible plastic flap bolted or otherwise fastened by a multiplicity of fasteners to a metal extender element are known. With this construction, the plastic flap simply flexes in the event it impacts a trailer during a turn.

Although cab extenders assist in enhancing the aerodynamics of a truck by deflecting air away from the gap between a truck cab and trailer or between successive trailers, further reductions in drag are desirable.

Therefore, a need exists for an improved cab extender.

### SUMMARY

It has been discovered that the provision of a plurality of openings spaced along the length of a rear edge portion of an extender or flap provides further reductions in drag. The shape of these openings can be varied as well as the number of such openings while still providing improved aerodynamic effects. For example, the provision of a single row of spaced apart triangular shaped openings that occupied no more than fifty percent of the area of an aluminum extension flap was tested in a wind tunnel. These tests were accomplished by directing an approximately 60 mile per hour wind in a wind tunnel against the front of a truck [at 0° yaw (parallel to the longitudinal axis of the vehicle) and at 6° yaw (offset by 6° from the longitudinal axis of the vehicle)]. The wind extended rearwardly across the cab extender and flap with a small portion of the wind entering the openings leading to the rear of the flap. The vast majority of the air followed the surface of the extender and flap and was diverted outside of the following trailer. The drag induced by such a head wind for extenders with and without opening containing extender flaps was compared. The embodiment with a triangular shaped opening as described below exhibited approximately a one percent reduction in drag. Other shaped openings were also tested and proved to reduce drag. A wind tunnel of the type disclosed in U.S. Pat. No. 6,820,477, was used for this testing.

It is believed that the reduction in drag occurs because the openings assist in relieving a vacuum that otherwise forms rearwardly of the cab between the cab and a following trailer (or between successive trailers). Although the space occupied by the openings can be increased beyond fifty percent, it is desirable to maintain a majority of the surface of the flap intact so as to divert a substantial portion of the air along the surface of the flap rather than through drag reducing openings.

The drag reducing openings in one desirable embodiment are in effect a plurality of air scoops as they are closed in this exemplary embodiment except along a rearwardly extending slit.

Although these drag reducing openings can be molded or otherwise formed in a flap or extender, in one desirable approach, edges bounding an opening are severed while leaving a retention hinge portion at the forward or leading edge of the opening. Consequently, the severed flap can be bent or pushed rearwardly away from the outer exterior surface of the flap with the hinge portion retaining the connection between the cutout portion of the flap and the remaining portions of the flap. For example, the flap may be displaced to provide a gap between the trailing edge of the flap and adjoining portions of the extender to between 0.05 and 0.3 inch with 0.1 to 0.2 inch being particularly desirable. Top and bottom boundaries above and below the displaced flap can be closed so that the only exit from the scoop is a rearwardly directed slit.

The opening defining components and the defined openings can otherwise be formed, such as by molding.

Various shaped openings can be used. In addition, there is no requirement that the openings be the same shape along the length of a given flap, although the utilization of symmetric openings is expected to provide more uniform aerodynamic characteristics and can be viewed as aesthetically pleasing.

The present invention is directed toward all new and non-obvious features and method as disclosed herein both individually and in various combinations and sub-combinations with one another. There is no requirement that an embodiment achieve any specific one or more, or all of the advantages set forth herein.

### BRIEF DESCRIPTION OF THE DRAWINGS

FIG. 1 is a side view of a semi-trailer truck having cab extenders according to a first embodiment.

FIG. 2 is a top plan view of a semi-trailer truck having cab extenders according to the first embodiment positioned along the sides of a cab and along the sides of a trailer.

FIG. 3 is a top plan view of a cab extender with air flow openings through the extender not visible in this figure.

FIG. 4 is a side elevational view of the cab extender of FIG. 3.

FIG. 5 is an exploded partially broken away isometric view of a cab extender according to the first embodiment.

FIG. 6 is a top plan view of the cab extender of FIG. 5.

FIG. 7 is a cross-sectional view of a portion of the cab extender of FIG. 6.

FIG. 8 is a top plan view of a cab extender according to a second embodiment.

FIG. 9 is a top plan view of a cab extender according to a third embodiment.

FIG. 10 is an enlarged view of a cab extender and attached flap having a plurality of lengthwise spaced apart drag reducing openings positioned along the length of the flap.

FIG. 11 is an enlarged side elevation view of a portion of the flap and extender of FIG. 10.

FIG. 12 is a transverse sectional view of a portion of the flap and extender of FIG. 11, taken along lines 12-12 of FIG. 11.

FIG. 13 is a vertical sectional view, taken along lines 13-13 of FIG. 11, illustrating an end view of a drag reducing opening.

FIG. 14 is a side elevation view of a portion of an alternative embodiment of an extender and flap.

FIG. 15 is a vertical sectional view, taken along lines 15-15 of FIG. 14.

FIG. 16 is a vertical end view, taken along lines 16-16 of FIG. 14.

FIG. 17 is a side elevational view of a portion of another example of an extender and flap, showing yet another drag reducing opening shape.

FIG. 18 is a transverse sectional view, taken along lines 18-18 of FIG. 17.

FIG. 19 is a side elevational view of yet another form of a flap showing non-symmetrical drag reducing openings.

### DETAILED DESCRIPTION

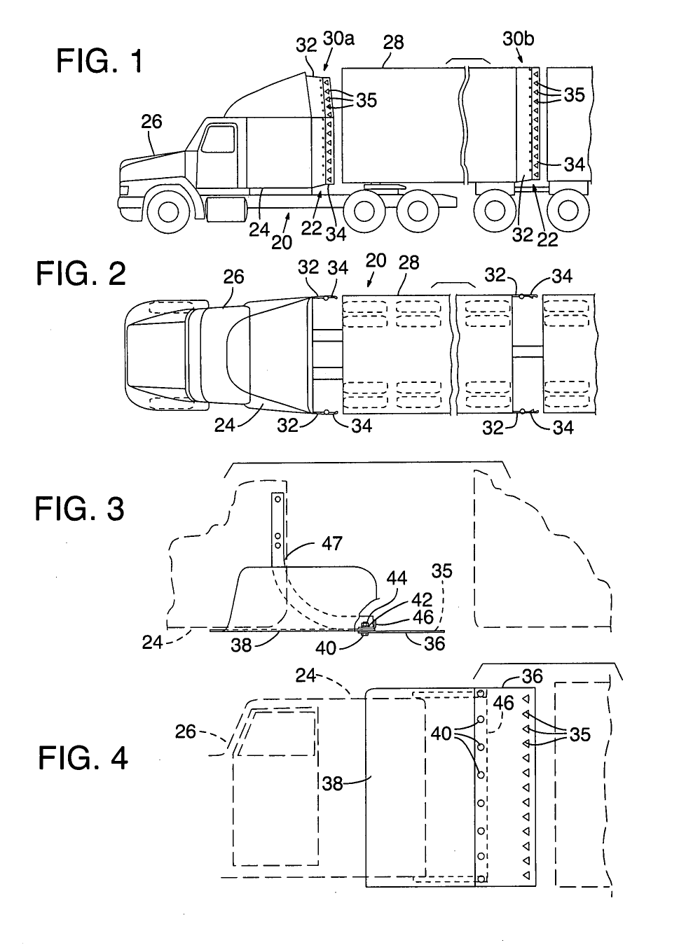

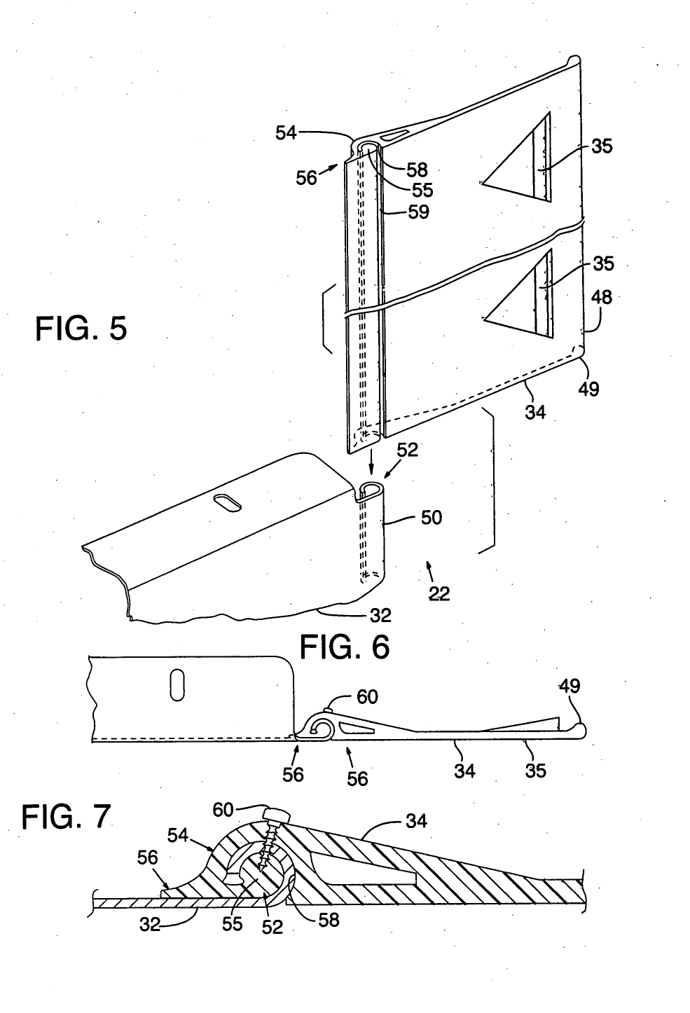

FIGS. 1 and 2 illustrate a semi-trailer truck 20 including cab extenders 22 according to one embodiment. While the cab extender 22 is primarily designed to close the gap 30a between the cab 24 of the tractor 26 and the trailer 28, the extender can be applied to the gap 30b between trailers as well. In addition, the cab extender can close the gap along the top of a tractor or trailer as well as along the sides thereof. As shown in greater detail in FIGS. 5 to 7, the illustrated cab extender 22 has two primary components or portions to fill these gaps: 1) an extender 32 typically mounted to the cab 24 and closing a portion of the gap 30a and/or 30b; and 2) a flap 34 mounted to the extender 32 or coupled to the extender by a support and filling in a second portion of the gap 30a and/or 30b. The flap 34 can be flexible or rigid. The flap 34 has a plurality of lengthwise spaced apart drag reducing openings 35 along its length as explained below.

FIGS. 3 and 4 depict a cab extender having a flap 36 that is comprised of metal, plastic or other suitable material and in the form shown is connected to the rear edge portion of a metal cab extender 38. The flap 36 is connected to the rear edge portion of the extender 38 by a multiplicity of metal capscrews 40, washers 42, and nuts 44. When mounted in place, the flap can be sandwiched between the metal extender and a metal reinforcing bracket 46. A metal bracket 47 holds the extender 38 at a desired angle relative to the cab 24.

The embodiment shown in FIG. 5 includes an extender 32, which is preferably made of a rigid material such as sheet metal, with aluminum (0.06 inch thick) being a specific example. As shown in FIGS. 1 and 2, the extender 32 is typically fastened to a cab 24 or trailer 28 and extends rearwardly across a portion of the gaps 30a and/or 30b. To close a second portion of these gaps 30a, 30b, the embodiment further includes a flap or extension edge portion 34. The flap 34 can be made of the same material as extender 32 or of one or more other materials, such as plastic, rubber or other flexible material. If a flap is made of a flexible material, it will flex and bend without damaging a downstream trailer in the event the trailer is engaged by the flap during a turn. To increase the rigidity and durability of the flap 34, the distal end of the flap 48 can optionally have an enlarged free edge, such as the rounded bead 49 extending the full length of the flap edge opposite to the flap edge which is coupled to the extender. In addition, the flap can be enlarged at the proximate or extender engaging edge to strengthen the flap where it is coupled to the extender. Although not required, the flap can be enlarged along the entire proximate edge.

Using plastic for the flap 34 simplifies its manufacture because the flap 34 can be molded with the drag reducing opening defining components and simply trimmed to length. Alternatively, the openings can be punched or otherwise formed. If punched, a hinge portion can be left in place to hinge an opening bounding back element to the flap. Specific exemplary materials for the flap include aluminum or other metal materials, composite materials, EPDM rubber, and high density polyethylene (HDPE) plastic. The thickness of the flap may vary, with one exemplary thickness being about 0.086 inch for HDPE, about 0.157 inch for EPDM rubber and about 0.06 inch for aluminum. The length of the flap is variable and typically corresponds to the top to bottom length of the gap. The width of the flap is also variable and is typically sized such that the flap and extender extend across about 50 to about 80 percent of the gap. Again, this is variable as the flap need only be wide enough to direct a significant portion of the air past the front of the downstream trailer. A typical flap is from about six to about twelve inches wide and in a desirable form is about six inches wide.

As shown in FIGS. 5 and 6, the illustrated extender 32 and flap 34 slidably engage each other along adjacent side edges. The illustrated extender 32 has a flange edge 50 defining a channel 52 for receiving the flap 34. The channel 50 in this case can assume any convenient cross-sectional shape, and can be generally circular as shown. To simplify its manufacture, this flange end 50 can be constructed from sheet metal with a side edge rolled into the partial circle 50. The flap has a channel receiving proximate or side edge 54 for insertion into the channel 52 of the extender 32. The channel receiving edge 54 in this embodiment is shaped to fit into and mate with the channel defining wall of the flange edge 50. In this embodiment, the flap side edge 54 includes a portion 55 of generally circular cross-section which is inserted into the interior of the channel 52. The flap side edge 54 defines a slot 59 shaped to receive the correspondingly shaped flange edge 50. The portion 55 is typically sized slightly larger in cross-sectional dimension than the extender channel 52 so that, when inserted, portion 55 is deformed slightly and increases the frictional engagement of the flap to the extender. The channel receiving edge 54′ may also include additional structure, such as the projecting lip edge 56 and extender engaging shoulder 58 which interlock the extender 32 and the flap. By interlock, it is meant that the structure, which may take other forms, prevents the flap 34 from pivoting or rotating relative to the extender 32. Because the extender 32 and flap 34 slidably engage each other, each portion may expand and contract relative to one another along the channel 52. As a result, the metal extender may expand and contract, for example, more rapidly than the flap 34 in response to temperature change, without wrinkling or thermally stressing the flap 34. However, if both the extender and the flap are of the same material, such as aluminum, they will expand and contract together even if the flap overlays the extender and is simply screwed, bolted or otherwise secured to the extender with plural fasteners.

The extender and flap in this FIG. 5 form are desirably sized to tightly mate together in frictional engagement. As a result, fasteners are not required. However, a fastener which allows relative expansion of the components can be employed. For example, a single screw or bolt type fastener may join the flap and extender. Consequently, the components are free to expand and contract relative to one another (those portions above the fastener are unrestricted from relative sliding and those portions below the fastener are similarly unrestricted) so that the flap does not wrinkle or buckle as a result of thermal stresses. In contrast, if plural spaced-apart fasteners are used, which can be used, the portion of the flap between two fasteners could buckle unless relative motion is otherwise accommodated or the materials have the same thermal expansion properties.

More specifically, FIGS. 6 and 7 illustrate a single self-tapping screw 60 that penetrates the extender and flap and firmly holds an inserted flap 34 in the channel 52 of the extender 32. The screw 60 is thus an additional optional means to ensure that the flap 34 does not loosen in the channel 52. Thus, while FIGS. 6 and 7 show a self-tapping screw, and such a fastener is typically employed, such a fastening device is neither needed nor required. As other examples, the flap 34 can be designed to snap into the flange 50 of the extender 32, or the flange 50 can simply be shaped to hold the channel receiving end 54 of the flap 34 in place. Alternatively, the flap 34 can be widened at the top such that this widened portion would engage the top of the channel 52 and comprise a stop to prevent the flap from sliding downward beyond the stop. Other stops can also be used.

The manner in which the flap 34 slidably engages the extender 32 facilitates the replacement or exchange of the flap 32. A cab can be provided with a standard extender, and the flap can changed as necessary to best close the gap depending upon factors such as the width of the cab relative to the trailer and the distance between the cab and trailer. While a standard width trailer is typically 96 or 102 inches wide, the cab width may vary substantially. The distance or width of the gap between cab and trailer may vary as well. As such, by providing flaps of different widths, a flap can be selected to more properly close the gap between the cab and trailer. Again, plural fasteners 40 can be used in the alternative.

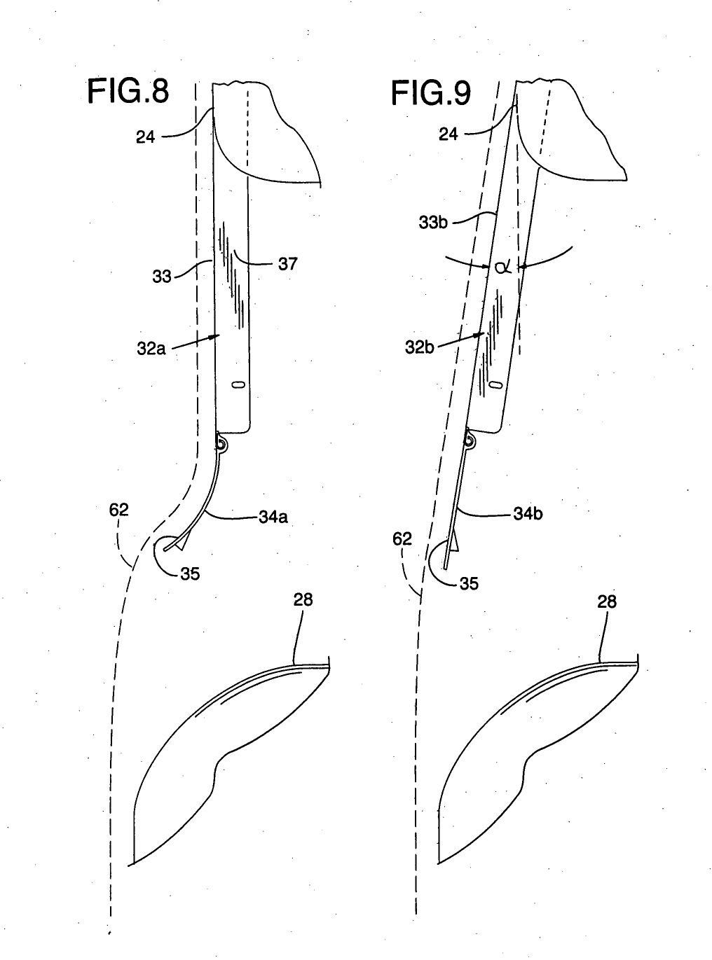

FIGS. 8 and 9 illustrate alternative embodiments of a cab extender which accommodates cabs of varying widths relative to a downstream trailer. In FIG. 8, the main body 33 of extender 32a (excluding an inwardly projecting top flange 37) is co-planar with the side of the cab 24, and the flap 34a is curved to direct airflow 62 around the trailer 28. In FIG. 9, the main body 33b of extender 32b is angled outwardly relative to the longitudinal axis and the side of the cab at an angle α. Although variable, α. is typically between about zero and about thirty degrees. The flap 34b, coupled to the angled extender, in this example, is a substantially planar member which, together with the extender 32b, directs air flow 62 around the trailer 28. From FIGS. 8 and 9, it can be seen that the extender 32b can be standardized at a fixed angle α, relative to the longitudinal axis of the cab. In addition, the flaps may be manufactured of various curved or otherwise shaped configurations and then selected to divert air past a downstream trailer for a given cab width and gap.

Other approaches for mounting cab extender flaps to a cap extender can also be used, such as disclosed in U.S. Pat. No. 5,658,038. As an alternative, the openings 35 can be formed in the extender 32, rather than in an attached flap or extension such as 34. However, the use of a flap 34 facilitates its separate replacement without requiring the replacement of the extender 32.

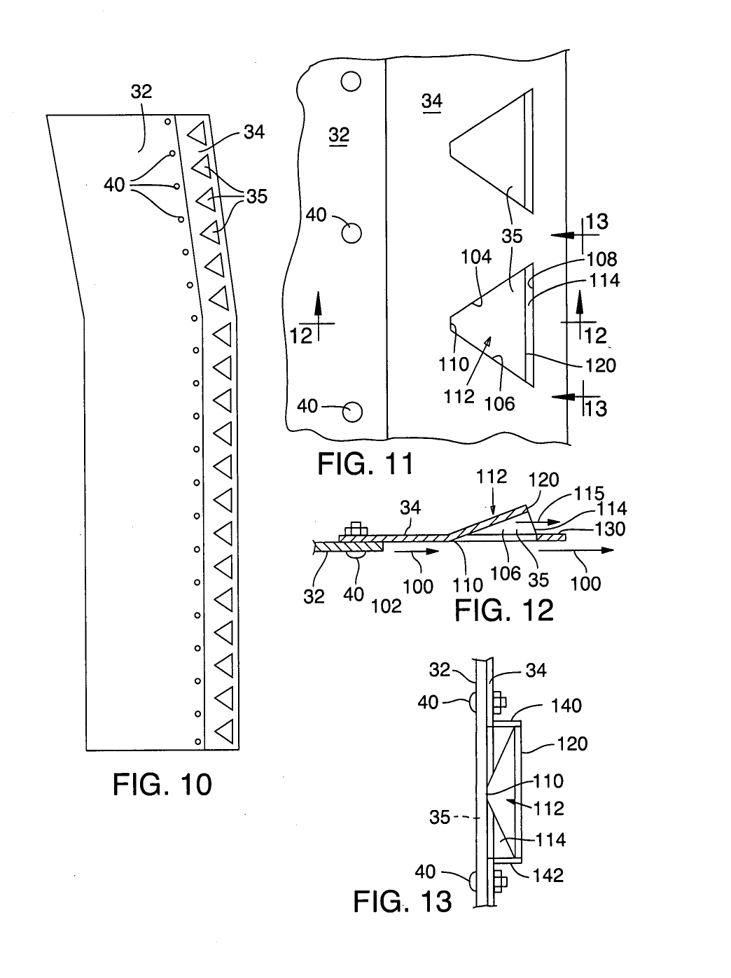

With reference to FIGS. 10-13, the cab extender 32 is shown with a flap 34 secured thereto, such as by cap screws 40. A plurality of spaced apart generally triangular shaped drag reduction openings 35 are provided in flap 34. These openings desirably are sized so that the bulk of the air (see arrows 100 in FIG. 12) passes along the exterior surface 102 of flap 34 and is diverted past a downstream trailer. Although variable, desirably less than fifty percent of the surface area of flap 34 is occupied by openings 35.

With reference to FIG. 11, in one specific approach, the flap 34 is made of aluminum or other metal. Upper and lower boundaries 104,106 and a rear boundary 108 of the opening are formed by cutting through the metal of the body of the flap 34 at these locations. An unsevered hinge portion 110 is left in place. As a result, a deflectable tab or flap element 112 is provided that can be pushed inwardly and away from the exterior surface 102 of the flap 34 (see FIG. 12). The trailing edge 120 of this deflectable tab 112 is shown in both FIGS. 11 and 12. As a result, an air flow gap 114, in this case a longitudinally or vertically extending slit is provided between the trailing edge 120 of deflection tab 112 and the rear surface 130 of flap 34. The width of the slit 114 can be varied with 0.05 inch to 0.3 inch being desirable and 0.1 to 0.2 inch being particularly desirable.

Triangular shaped openings as shown in FIG. 11, with an air slit having a width of 0.2 inch, resulted in a one percent reduction in measured drag (compared to the truck with two extenders and flaps without openings 35) in a wind tunnel when a truck was impacted with air traveling at 60 miles per hour at 0° and 6° yaw. In this example, there were two extenders and extender flaps, one at each side of the truck. Each flap had twelve such triangular shaped openings 35 having side edges 104 and 106 of a length of one and one-half inches and a rear edge 108 of a two inch length. In addition, the top and bottom edges of the deflection tab 112 were closed by upper and lower closure pieces 140,142 (see FIG. 13). In an alternative approach, the top and bottom portions of the opening were closed by tape overlying the rear of the tab 112. Therefore, in this example, the only exit from the air scoop formed by the deflection tab 112 was through the slit 114. As indicated by arrow 115 in FIG. 12, only a small quantity of air actually passes through the exit slit 114. This air 115 assists in reducing a vacuum that is believed to otherwise form behind the flap 34 to thereby reduce the drag caused by the extender.

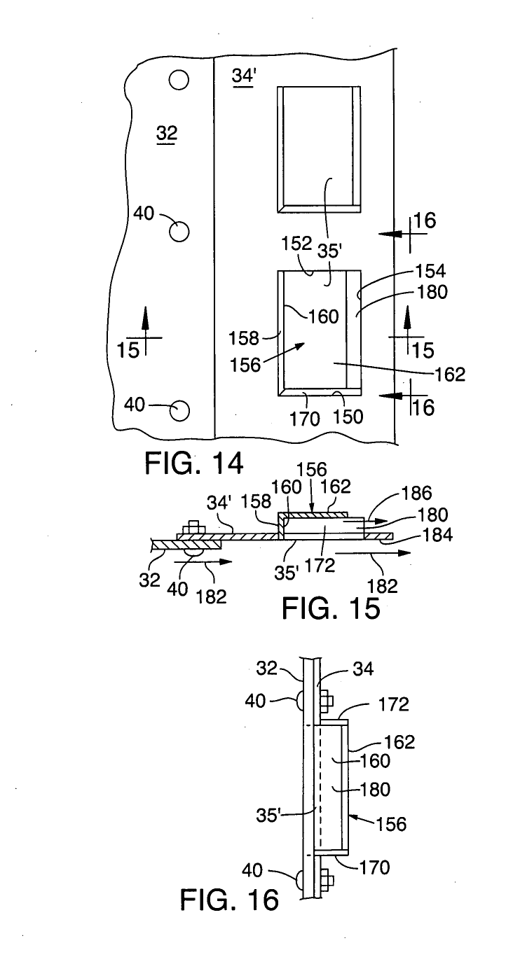

FIGS. 14-16 illustrate a flap 34′ having rectangularly shaped openings 35′. The prime designation simply indicates an alternative embodiment. In the embodiment of FIG. 14, in one manufacturing approach, lower and upper boundaries 150,152 and a rear boundary 154 of a displaceable air deflection tab 156 are formed, leaving a hinge portion 158. The hinge portion 158 can be bent as shown in FIG. 15 to provide first and second wall portions 160,162 with wall portion 160 extending away from the main body of the flap 34′ and the wall portion 162 extending parallel to the main body of the flap. Alternatively, the air deflection tab 156 can be bent in the manner shown in FIG. 12. The top and bottom portions of this defined opening can be closed, such as by closure members 170,172 shown respectively in FIGS. 14 and 15. When closed in this manner, air exits through a rearwardly extending slit 180 in this example. The bulk of the air, indicated by arrows 182 in FIG. 15, passes along the exterior surface 184 of flap 34′ and is deflected along the outer sides of the following trailer. A small amount of air, indicated by arrow 186, passes through the opening 180 to again relieve the vacuum behind the flap and reduce the drag. This construction is also illustrated in FIG. 16.

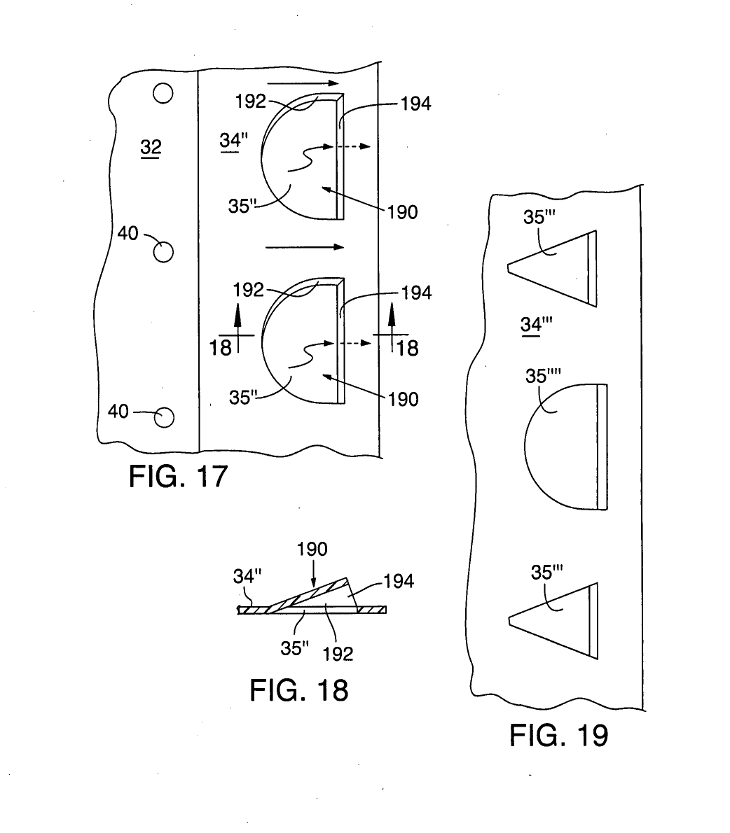

FIGS. 17 and 18 illustrate an embodiment of a flap 34″ with semi-circular air deflection tabs 190 closed at their perimeter by closure member 192 and having an air exit slit 194 as can be seen in FIG. 18.

FIG. 19 illustrates an embodiment 34′″ with air deflection openings of varying shapes 35′″, 35″″ to illustrate that, although desirable, the air deflection openings are not required to be symmetrical.

In a particularly desirable form, the air deflection scoops have a rearwardly extending exit opening, such as in the form of a slit. However, the openings are not be limited to this shape or to this location. Also, although less desirable, the upper and lower boundaries of the air deflection scoops can be left entirely or partially open.

Having illustrated and described the principles of our developments with respect to several desirable embodiments, it should be apparent to those of ordinary skill in the art that these embodiments can be modified in arrangement and detail without departing from the inventing principles disclosed herein. We claim all such modifications.

We claim:

1. A vehicle extender for at least partially closing the gap between an upstream vehicle and a downstream or towed trailer, the extender comprising:
a member adapted for coupling to the upstream vehicle, the member comprising an exterior surface positioned such that air flows along the exterior surface in an upstream to downstream direction when the member is coupled to the upstream vehicle and the upstream vehicle is traveling in a forward direction, the member comprising an interior surface opposed to the exterior surface and a downstream rear edge portion;
a plurality of continuously open air scoops positioned at spaced apart locations along the member, each of said plurality of scoops comprising an air flow entrance opening positioned to receive some of the air flowing along the exterior surface, an air flow directing portion projecting from the interior surface and communicating with the air flow entrance opening, the air flow directing portion comprising an air flow exit opening communicating with the space between the upstream vehicle and downstream or towed trailer, such that a portion of the air flowing along the exterior surface flows through the air directing portion and through the air flow exit opening.

2. A vehicle extender according to claim 1 wherein at least a plurality of the scoops have a triangularly shaped air flow entrance opening at the exterior surface.

3. A vehicle extender according to claim 2 wherein each of the triangularly shaped air flow entrance openings is associated with a respective air flow exit opening and is oriented with the apex of the triangle positioned at an upstream position relative to the associated air flow exit opening.

4. A vehicle extender according to claim 1 wherein the plurality of air scoops are of at least two different shapes.

5. A vehicle extender according to claim 1 wherein the air flow exit openings each comprise a downstream facing slit.

6. A vehicle extender according to claim 1 wherein the slits are from 0.05 inch to 0.3 inch in depth.

7. A vehicle extender according to claim 5 wherein the only air flow exit opening for each scoop is one of the downstream facing slits.

8. A vehicle extender according to claim 1 wherein each of the air flow directing portions comprises a back wall formed at least in part by cutting all but a connecting tab portion of a section of the first portion in the shape of the air inlet opening and bending the cut portion, with the tab comprising a bending hinge, away from the remaining uncut exterior surface of the first portion to form at least a part of the back wall of the air flow directing portion.

9. A vehicle extender according to 8 wherein each air directing portion has respective wall portions extending from the interior surface to the back wall to close the air directing portion except at the air flow exit opening.

10. A vehicle extender according to claim 1 wherein the member comprises a rigid vehicle extender member.

11. A vehicle extender according to claim 1 wherein the member comprises a flexible flap with a downstream rear edge, the air scoops being spaced upstream from the rear edge.

12. A vehicle extender according to claim 1 comprising a first extender portion for coupling to the upstream vehicle and for coupling to the member, wherein the member comprises a flap.

13. A vehicle extender according to claim 1 comprising a flap coupled to the rear edge portion of the member.

14. A vehicle extender according to claim 1 wherein the member comprises a downstream edge bounding the downstream rear edge portion and wherein the air inlet openings of said plurality of scoops are positioned in the downstream rear edge portion and are located spaced in an upstream direction from the rear edge.

15. A vehicle extender according to claim 1 wherein the upstream vehicle is a tractor.

16. A vehicle extender according to claim 1 wherein the upstream vehicle is a trailer.

17. A vehicle extender for at least partially closing the gap between an upstream vehicle and a downstream or towed trailer, the extender comprising:
an elongated body for coupling to the upstream vehicle, the body comprising an exterior surface;
a plurality of air scoops positioned along the length of the body and configured to direct a portion of the air flowing along the exterior surface when the body is coupled to the upstream vehicle and the upstream vehicle is traveling in a forward direction toward the space between the upstream vehicle and the downstream or towed trailer.

18. A vehicle extender according to claim 17 wherein there are at least five of said air scoops positioned along the length of the body.

19. A vehicle extender according to claim 17 wherein there are at least 12 of said air scoops positioned along the length of the body.

20. A vehicle extender for coupling to an upstream vehicle for at least partially closing the gap between an upstream vehicle and a downstream or towed trailer, the extender comprising:
an extender portion adapted for coupling to a vehicle, the extender portion comprising an extender edge portion;
flap portion adapted for coupling to the extender edge portion, the flap portion comprising exterior and interior flap surfaces and a flap edge portion spaced from the extender edge portion;
a plurality of air flow guides positioned at spaced apart locations along the flap portion, each of said plurality of air flow guides comprising an air flow entrance opening and an air flow directing portion communicating with the air flow entrance opening, the air flow directing portion comprising an air flow exit opening for communicating with the space between the upstream vehicle and downstream or towed trailer.

21. A vehicle extender according to claim 20 wherein the flap is comprised of a plastic material.

22. A vehicle extender according to claim 20 wherein the air flow guides comprise air scoops.

23. A vehicle extender according to claim 22 wherein there are at least twelve scoops in the flap portion.

24. A vehicle extender according to claim 20 wherein the air flow entrance openings are spaced along the length of the flap portion and are positioned inwardly from the flap edge portion.
